(19) United States
(12) Patent Application Publication
(10) Pub. No.: US 2006/0196191 A1
(43) Pub. Date: Sep. 7, 2006

(54) Gas turbine engine

(76) Inventor: William Delaplaine Green JR., Bethlehem, PA (US)

Correspondence Address: WILLIAM DELAPLAINE GREEN, 8906 CAMDEN ST., ALEXANDRIA, VA, 22308, US

(21) Appl. No.: 11/072,539

(22) Filed: Mar. 7, 2005

(51) Int. Cl. F02C 7/266

(52) U.S. Cl. 60/776; 60/39.827

(57) ABSTRACT

A gas turbine engine uses a carburetor or a fuel injector and spark ignition devices to fuel and fire it. A gear pump compresses the air/fuel mixture into a compressor discharge passage connected to ignition holes. The spark ignition devices thread into the ignition holes and ignite the combustible mixture which is pumped up through the ignition holes into horizontal combustion passages that flow the burning gas in between the turbine rotors on their downstream side. The gas pressure forces the turbine rotors in each pair of turbines to accelerate in opposite directions. The turbine rotors are located on the compressor drive shafts and drive the counter rotating compressor rotors. The combustion gas flows through the top sides of the turbines and flows out the sides of the housing through exhaust ports. Another embodiment uses a fuel injector and the combustion gas is pumped into the upstream side of the turbines.

### BACKGROUND OF THE INVENTION

Gas turbine engines are well known in the art and many embodiments have been patented. These include the well known aircraft jet engine which is designed to produce exhaust thrust, the turbo prop gas turbine engine designed to drive a propeller and produce exhaust thrust as commonly seen in high bypass jumbo jet applications that have greater fuel efficiency, and gas turbine engines designed to produce shaft horse power or torque commonly used to drive helicopter rotors. In each case gas turbine engines are continuous combustion machines and are generally employed as suitable aero engines. The instant invention is also designed to produce torque or shaft horse power but is primarily intended for land vehicle propulsion where wheel drive and fuel efficiency are required. This engine may also be designed to produce thrust as well as torque.

These engines may be regarded as hybrid engines combining the features of internal combustion engines and gas turbine engines to produce a new type of engine suitable for a multitude of applications as ground, sea, air, and space power sources. This invention is unique in that it can use a standard automotive type carburetor to supply it with a fuel and air mixture and a standard spark plug to ignite the combustible mixture. Alternatively it may be fuel injected and achieve diesel ignition if a combustion operated valve is used. The design is simple to manufacture and inexpensive, and more efficiently produces a competitive power to weight ratio compared to automotive type internal combustion engines.

### SUMMARY OF THE INVENTION

The invention is a gas turbine engine comprised of a housing assembly divided horizontally along the axis of compressor shaft holes. Bolt holes passing through the top half of the housing assembly thread into the bottom half of the housing assembly bolting the two housing halves securely together. End plates bolt to each end of the housing assembly and have bearing enclosures projecting from their outer walls. Two compressor shaft holes pass through the housing assembly from one end to the opposite end and enclose two compressor shafts. Each compressor shaft carries on it a center compressor rotor and to each side of this compressor rotor is a turbine or paddlewheel rotor. The housing assembly contains appropriate enclosures to enclose the compressor shafts, the compressor rotors and the paddlewheel or turbine rotors.

A center compressor compresses air and fuel into a compressor discharge passage. An intake port formed in the top of the housing assembly passes air to the compressor. In one embodiment a carburetor is fastened to the housing assembly top wall above this intake port. Spark ignition devices thread into the bottom housing wall into the ignition holes and ignite the fuel mixture. In one embodiment the compressor discharge passage extends from an ignition hole located in an inside housing wall to another ignition hole located in another inside housing wall. Combustion passages connect these ignition holes to the outer walls of turbine rotor holes in between the turbines on their downstream side. The burning gases are pumped by a gear pump compressor up through the ignition holes into the combustion passages and in between each set of turbines. The high pressure gas flows through the turbines forcing them to accelerate in opposite directions driving the counter rotating compressor rotors. The exhaust gases pass out of exhaust ports formed in the sides of the housing assembly.

In another embodiment the ignition holes located in the housing walls between the compressor rotor holes and the turbine rotor holes connect to the center compressor discharge passage and combustion passages that project outward to the outer walls of the turbine rotor holes in between the turbines on their upstream side. Spark ignition devices thread into the ignition holes and ignite the fuel and air mixture in them. Combustion gas is pumped into the two sets of turbine holes and forces its way in between the turbine rotors forcing them to accelerate, driving the compressor, and passes out of the engine through top exhaust ports.

In all embodiments specified and illustrated, an engine management system well known in the art, including sensor means, transducer means, connection means, control means, computer means, and accessory means such as fuel supply means, current supply means, coolant supply means, and starting and stopping means and any performance enhancing means available may be used to completely control engine performance characteristics to achieve maximum power, efficiency, and reliability.

### BRIEF DESCRIPTION OF THE DRAWINGS

### Submitted with Preliminary Drawings

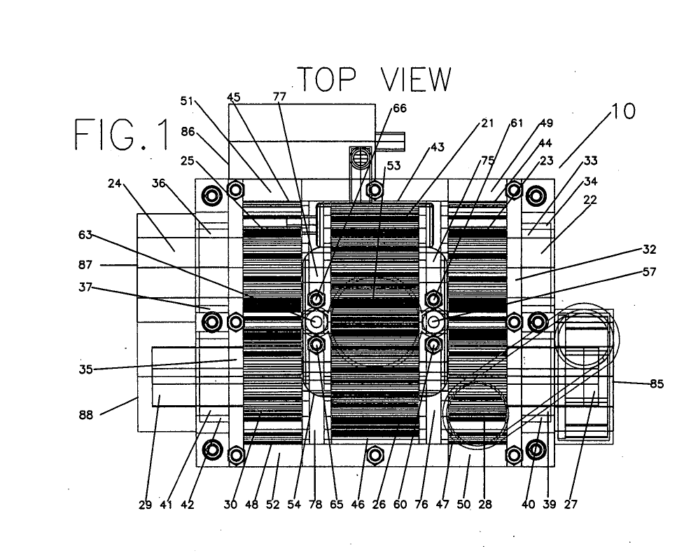

1. FIG. 1 is a top view of a wire frame illustration of a gas turbine engine in accordance with one embodiment of the invention.

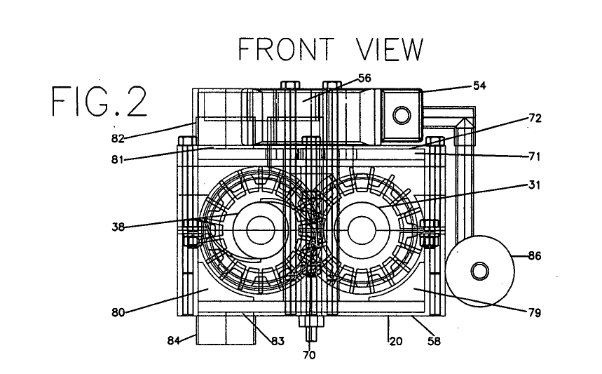

2. FIG. 2 is a front view of a wire frame illustration of the gas turbine engine shown in FIG. 1.

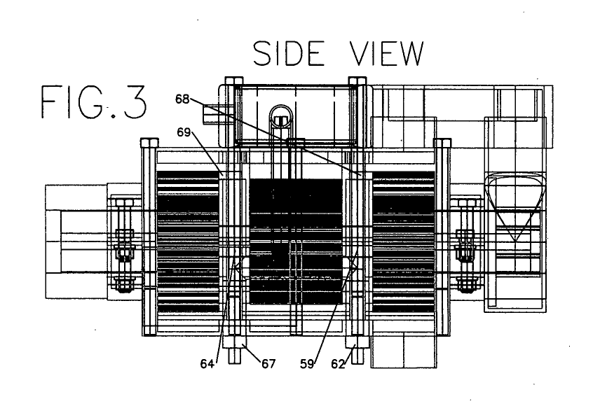

3. FIG. 3 is a side view of a wire frame illustration of the gas turbine engine shown in FIG. 1

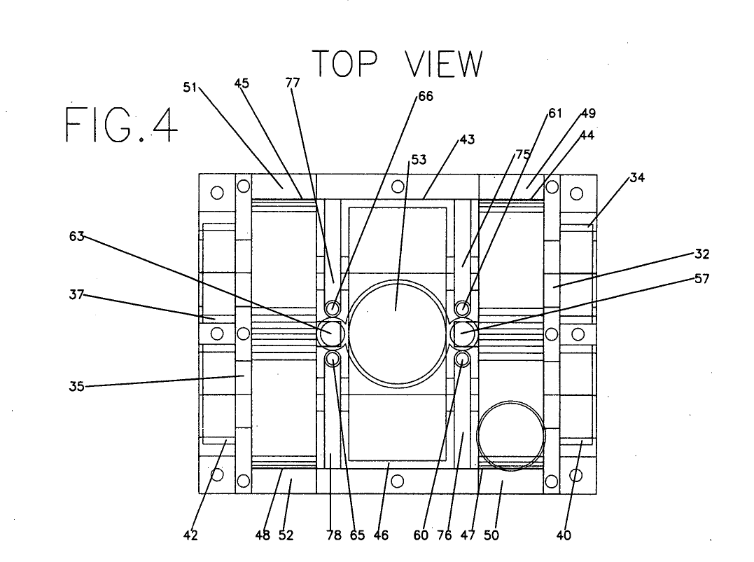

4. FIG. 4 is a top view of a wire frame illustration of the housing of the gas turbine engine shown in FIG. 1.

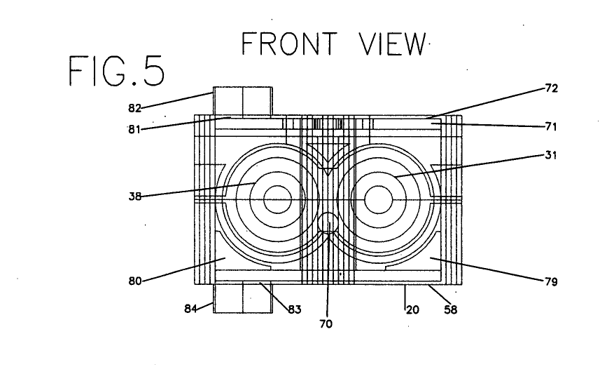

5. FIG. 5 is a front view of a wire frame illustration of the housing of the gas turbine engine shown in FIG. 1.

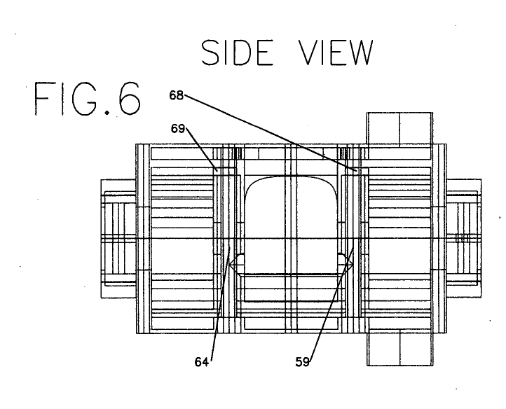

6. FIG. 6 is a side view of a wire frame illustration of the housing of the gas turbine engine shown in FIG. 1.

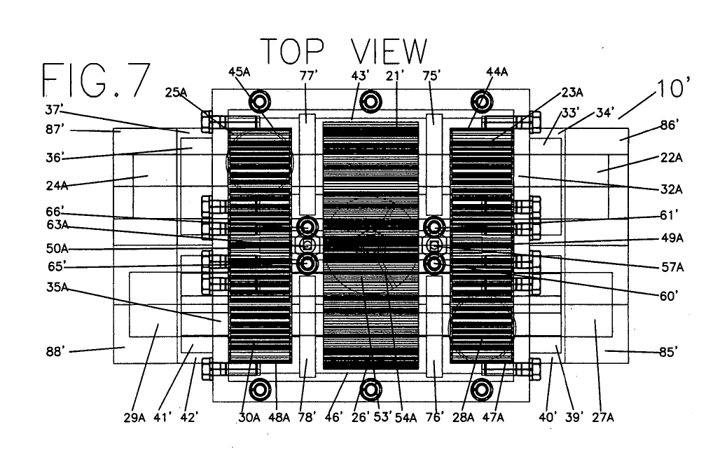

7. FIG. 7 is a top view of a wire frame illustration of a gas turbine engine in accordance with another embodiment of the invention.

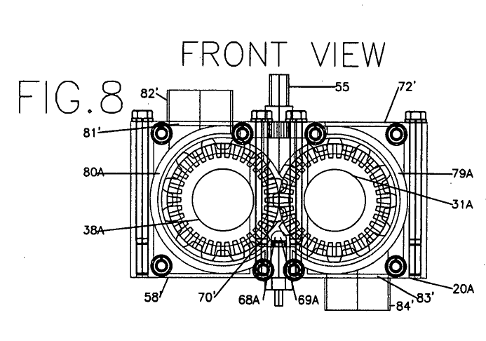

8. FIG. 8 is front view of a wire frame illustration of the gas turbine engine shown in FIG. 7.

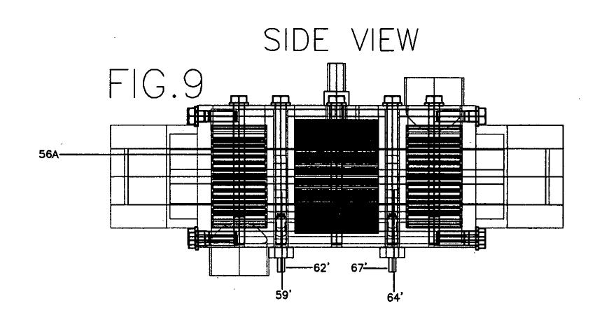

9. FIG. 9 is a side view of a wire frame illustration of the gas turbine engine shown in FIG. 7.

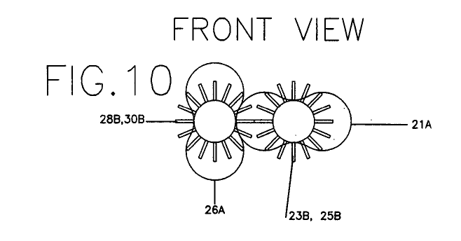

10. FIG. 10 is a front view of a wire frame illustration of an alternative compressor shaft of the gas turbine engine shown in FIG. 7.

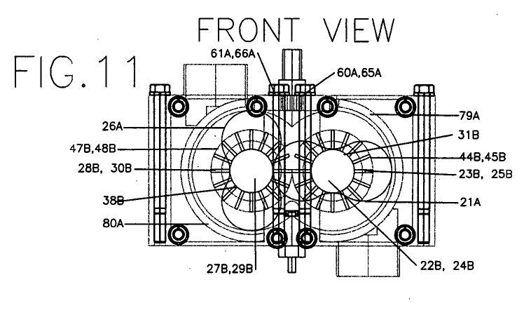

11. FIG. 11 is a front view of a wire frame illustration of the gas turbine engine using the compressor shaft shown in FIG. 10.

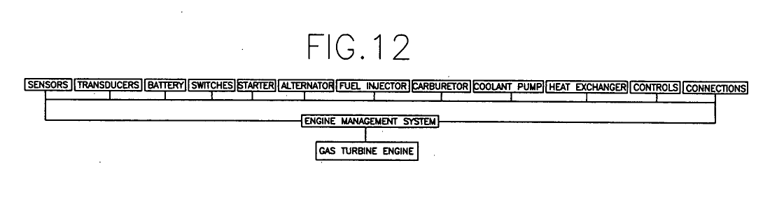

12. FIG. 12 is a diagram of an engine management system and the parts connected to it, well known in the art, used to control engine functioning.

### DESCRIPTION OF THE PREFERRED EMBODIMENTS

Referring now to the drawings in detail, FIG. 1-FIG. 6, FIG. 12 illustrate a gas turbine engine constructed in accordance with one embodiment generally referred to by reference number 10. In this embodiment the engine is enclosed by a housing assembly 20 containing a compressor rotor 21 having a drive shaft 22, extending from one side, which has a turbine rotor 23 that is round and extends from the surface of the drive shaft 22, a drive shaft 24 extending from the other side which has a turbine rotor 25 that is round and extends from the surface of the drive shaft 24. The drive shafts 22 and 24 are a smaller diameter between the compressor rotor 21 and the turbine rotors 23 and 25. The housing assembly 20 also contains a compressor rotor 26 having a drive shaft 27 extending from one side which has a turbine rotor 28 that is round and extends from the surface of the drive shaft 27, and a drive shaft 29 extending from the other side which has a turbine rotor 30 that is round and extends from the surface of the drive shaft 29. The drive shafts 27 and 29 are a smaller diameter between the compressor rotor 26 and the turbine rotors 28 and 30. The compressor rotors 21 and 26 form part of the compressor of the engine. The turbine rotors 23, 25, 28, and 30 form part of the turbine of the engine.

The housing space contains the drive shaft 22 which extends through a compressor drive shaft hole 31 in an outer housing wall 32 and is supported by a bearing 33 enclosed in a bearing enclosure 34 projecting from an outside surface of the outer housing wall 32. The drive shaft 24 extends through the compressor drive shaft hole 31 in an opposite outer housing wall 35 and is supported by a bearing 36 enclosed in a bearing enclosure 37 projecting from an outside surface of the opposite outer housing wall 35. The drive shaft 27 extends through a compressor drive shaft hole 38 in the outer housing wall 32 and is supported by a bearing 39 enclosed in a bearing enclosure 40 projecting from an outside surface of the outer housing wall 32. The drive shaft 29 extends through the compressor drive shaft hole 38 in the opposite outer housing wall 35 and is supported by a bearing 41 enclosed in a bearing enclosure 42 projecting from an outside surface of the opposite outer housing wall 35.

The housing assembly 20 has formed within it a compressor rotor hole 43, with a turbine rotor hole 44 formed to one side and a turbine rotor hole 45 formed to the opposite side. The compressor drive shaft hole 31 passes from the outside of the bearing enclosure 34 to the outside of the bearing enclosure 37 and is axially aligned with the compressor rotor hole 43 and the turbine rotor holes 44 and 45. The drive shaft hole 31 is a smaller diameter between the compressor rotor hole 43 and the turbine rotor holes 44 and 45. The housing assembly 20 has formed within it a compressor rotor hole 46, with a turbine rotor hole 47 formed to one side and a turbine rotor hole 48 formed to the opposite side. The compressor drive shaft hole 38 passes from the outside of the bearing enclosure 40 to the outside of the bearing enclosure 42 and is axially aligned with the compressor rotor hole 46 and the turbine rotor holes 47 and 48. The drive shaft hole 38 is a smaller diameter between the compressor rotor hole 46 and the turbine rotor holes 47 and 48.

The turbine rotor 23 axially aligns within the turbine rotor hole 44, the compressor rotor 21 axially aligns within the compressor rotor hole 43, the turbine rotor 25 axially aligns within the turbine rotor hole 45, the drive shaft 22 and the drive shaft 24 axially align within the compressor drive shaft hole 31. The turbine rotor 28 axially aligns within the turbine rotor hole 47, the compressor rotor 26 axially aligns within the compressor rotor hole 46, the turbine rotor 30 axially aligns within the turbine rotor hole 48, the drive shaft 27 and the drive shaft 29 axially align within the compressor output shaft hole 38. The compressor rotors 21 and 26 mesh together inside the compressor rotor holes 43 and 46 to form a positive displacement gear pump that functions as the engine compressor.

An exhaust port 49 projects through the side of the housing assembly 20 into the turbine rotor hole 44, an exhaust port 50 projects through the side of the housing assembly 20 into the turbine rotor hole 47, an exhaust port 51 projects through the side of the housing assembly 20 into the turbine rotor hole 45, an exhaust port 52 projects through the side of housing assembly 20 into the turbine rotor hole 48. The housing assembly 20 is divided in half along the axis of the compressor drive shaft hole 31 and the compressor drive shaft hole 38 and bolts passing through the top housing half thread into the bottom housing half to secure the housing halves together.

An intake port 53 is formed in the top of the housing assembly 20, and a carburetor 54 or a fuel injector is attached to the top of the housing assembly 20 and form part of the fuel supply of the engine. The carburetor 54 or the fuel injector, if used, are axially aligned with the intake port 53. A throttle butterfly valve 56 is located in the carburetor barrel to control air flow. An ignition hole 57 projects through the housing bottom wall 58 up through the center of the inner housing wall 59 located between the compressor rotor holes 43 and 46 and the turbine rotor holes 44 and 47. A bolt hole 60 located to one side of the ignition hole 57 and a bolt hole 61 located to the other side of the ignition hole 57 project up through the inner housing wall 59 passing from the bottom to the top of the housing assembly 20. A spark ignition device 62 threads into the ignition hole 57, so the electrode is located inside the ignition hole 57, and fastens against the housing bottom wall 58, to form part of the ignition system of the engine. An ignition hole 63 projects through the housing bottom wall 58 up through the center of the inner housing wall 64 located between the compressor rotor holes 43 and 46 and the turbine rotor holes 45 and 48. A bolt hole 65 located to one side of the ignition hole 63 and a bolt hole 66 located to the other side of the ignition hole 63 project up through the inner housing wall 64 passing from the bottom to the top of the housing assembly 20. A spark ignition device 67 threads into the ignition hole 63, so the electrode is located inside the ignition hole 63, and fastens against the housing bottom wall 58. Bolts thread into the bottom half of the bolt holes 60, 61, 65, and 66 and fasten the carburetor 54 to the housing assembly 20.

A combustion passage 68 is formed in the housing assembly 20 between the outer walls of the turbine rotor holes 44 and 47 and passes horizontally through the housing assembly 20 connecting to the ignition hole 57. A combustion passage 69 is formed in the housing assembly 20 between the outer walls of the turbine rotor holes 45 and 48 and passes horizontally through the housing assembly 20 connecting to the ignition hole 63. A compressor discharge passage 70 connects the ignition hole 57 to the ignition hole 63.

A top horizontal coolant passage 71 formed in the housing top wall 72 extends from inside one side of the housing assembly 20 to inside the opposite side and from behind the housing front wall 32 to in front of the housing back wall 35. A vertical coolant passage 75 is formed in the inner housing wall 59 and is located between the compressor rotor hole 43 and the turbine rotor hole 44 and connects to the top horizontal cooling passage 71 and extends downward surrounding the drive shaft 22. A vertical coolant passage 76 is formed in the inner housing wall 59 and is located between the compressor rotor hole 46 and the turbine rotor hole 47 and connects to the top horizontal cooling passage 71 and extends downward surrounding the drive shaft 27. A vertical coolant passage 77 is formed in the inner housing wall 64 and is located between the compressor rotor hole 43 and the turbine rotor hole 45 and connects to the top horizontal cooling passage 71 and extends downward surrounding the drive shaft 24. A vertical coolant passage 78 is formed in the inner housing wall 64 and is located between the compressor rotor hole 46 and the turbine rotor hole 48 and connects to the top horizontal cooling passage 71 and extends downward surrounding the drive shaft 29.

A side horizontal coolant passage 79 connects the vertical coolant passage 75 and the vertical coolant passage 77 together and extends from behind the housing front wall 32 to in front of the housing back wall 35. A side horizontal coolant passage 80 connects the vertical coolant passage 76 and the vertical coolant passage 78 together and extends from behind the housing front wall 32 to in front of the housing back wall 35.

A coolant inlet hole 81 passes through the housing top wall 72 and connects to the top horizontal coolant passage 71. A coolant inlet flange 82 projects upward from the surface of the housing top wall 72 and is axially aligned with the coolant inlet hole 81. A coolant outlet hole 83 passes through the housing bottom wall 58 connecting to the side horizontal coolant passage 80. A coolant outlet flange 84 projects downward from the surface of the housing bottom wall 58 and is axially aligned with the coolant outlet hole 83.

To start the engine an on/off switch is thrown to energize a starter 87 that rotates the drive shaft 24. Rotation of the drive shaft 24 rotates the compressor rotor 21. Rotation of the compressor rotor 21 rotates the compressor rotor 26 and the compressor draws air into the engine through the intake port 53, through the carburetor 54, and the fuel/air mixture is discharged into the compressor discharge passage 70 and flows into the ignition holes 57 and 63. The spark ignition devices 62 and 67 ignite the fuel mixture and the hot gases pass into the combustion passages 68 and 69. Gases in the combustion passage 68 flows into the turbine rotor holes 44 and 47 and the gas pressure between the counter rotating turbine rotors 23 and 28 drives them in opposite directions accelerating them. Gases in the combustion passage 69 flows into the turbine rotor holes 45 and 48 and the gas pressure between the counter rotating turbine rotors 25 and 30 drives them in opposite directions accelerating them. The turbine rotors 23 and 25 drive the drive shafts 22 and 24 which drive the compressor rotor 21. The turbine rotors 28 and 30 drive the drive shafts 27 and 29 which drive the compressor rotor 26. Gas pressure driving the turbine rotors 23, 25, 28, and 30 passes out of the side exhaust ports 49, 50, 51, and 52. Acceleration of the compressor rotors 21 and 26 draws more air through the carburetor 54 increasing the amount of fuel and air burned per unit time increasing the engines power. A coolant pump 85 pumps coolant through the engine coolant passages, a fuel pump 86 supplies fuel, and an alternator 88 supplies running current. An engine management system controls engine operation and performance.

Referring now to the drawings in detail, FIG. 7-FIG. 12 illustrate a gas turbine engine constructed in accordance with a second embodiment generally referred to by reference number 10′. In this embodiment the engine is enclosed by a housing assembly 20A containing a compressor rotor 21′, having a drive shaft 22A, extending from one side which has a turbine rotor 23A, that is round and extends from the surface of the drive shaft 22A, and a drive shaft 24A, extending from the other side which has a turbine rotor 25A, that is round and extends from the surface of the drive shaft 24A. The housing 20A also contains a compressor rotor 26′, having a drive shaft 27A, extending from one side which has a turbine rotor 28A, that is round and extends from the surface of the drive shaft 27A, and a drive shaft 29A extending from the other side which has a turbine rotor 30A, that is round and extends from the surface of the drive shaft 29A. The compressor rotors 21′ and 26′ form part of the compressor of the engine. The turbine rotors 23A, 25A, 28A, and 30A form part of the turbine of the engine.

The drive shaft 22A extends through a compressor drive shaft hole 31A, in a detachable outer housing wall 32A and is supported by a bearing 33′ enclosed in a bearing enclosure 34′ projecting from an outside surface of the detachable outer housing wall 32A. The drive shaft 24A extends through the compressor drive shaft hole 31A in an opposite detachable outer housing wall 35A and is supported by a bearing 36′ enclosed in a bearing enclosure 37′ projecting from an outside surface of the opposite detachable outer housing wall 35A. The drive shaft 27A extends through a compressor drive shaft hole 38A in the detachable outer housing wall 32A and is supported by a bearing 39′ enclosed in a bearing enclosure 40′ projecting from an outside surface of the detachable outer housing wall 32A. The drive shaft 29A extends through the compressor output shaft hole 38A in the opposite detachable outer housing wall 35A and is supported by a bearing 41′ enclosed in a bearing enclosure 42′ projecting from an outside surface of the opposite detachable outer housing wall 35A.

The housing assembly 20A has formed within it a compressor rotor hole 43′, with a turbine rotor hole 44A, formed to one side and a turbine rotor hole 45A, formed to the opposite side. The compressor drive shaft hole 31A passes from the outside of the bearing enclosure 34′ to the outside of the bearing enclosure 37′ and is axially aligned with the compressor rotor hole 43′ and the turbine rotor holes 44A and 45A. The housing assembly 20A has formed within it a compressor rotor hole 46′, with a turbine rotor hole 47A, formed to one side and a turbine rotor hole 48A, formed to the opposite side. The compressor drive shaft hole 38A passes from the outside of the bearing enclosure 40′ to the outside of the bearing enclosure 42′ and is axially aligned with the compressor rotor hole 46′ and the turbine rotor holes 47A and 48A.

The turbine rotor 23A axially aligns within the turbine rotor hole 44A, the compressor rotor 21′ axially aligns within the compressor rotor hole 43′, the turbine rotor 25A axially aligns within the turbine rotor hole 45A, the drive shaft 22A and the drive shaft 24A axially align within the compressor drive shaft hole 31A. The turbine rotor 28A axially aligns within turbine rotor hole 47A, the compressor rotor 26′ axially aligns within the compressor rotor hole 46′, the turbine rotor 30A axially align within the turbine rotor hole 48A, the drive shaft 27A and the drive shaft 29A axially align within the compressor drive shaft hole 38A. The compressor rotors 21′ and 26′ mesh together inside compressor rotor holes 43′ and 46′ to form a positive displacement gear pump that functions as the engine compressor. A lobular gear type compressor shown in FIG. 10 and FIG. 11 may be used.

An exhaust port 49A projects down through the housing assembly 20A into the turbine rotor holes 44A and 47A. An exhaust port 50A projects down through the housing assembly 20A into the turbine rotor hole 45A and 48A. The housing assembly 20A is divided in half along the axis of the compressor drive shaft hole 31A and the compressor drive shaft hole 38A and bolts passing through the top housing half thread into the bottom housing half to secure the housing halves together.

An intake port 53′ is formed in the top of the housing assembly 20A. An injector holder 54A is formed within the intake port 53′ and a fuel injector 55 is secured inside the injector holder 54A. The fuel injector 55 is axially aligned with the intake port 53′. All turbine rotors have side walls 56A. An ignition hole 57A projects through the housing bottom wall 58A up through the center of the inner housing wall 59′ located between the compressor rotor holes 43′ and 46′ and the turbine rotor holes 44A and 47A. A bolt hole 60′ located to one side of the ignition hole 57A and a bolt hole 61′ located to the other side of the ignition hole 57A project up through the inner housing wall 59′ passing from the bottom to the top of the housing assembly 20A. A spark ignition device 62′ threads into the ignition hole 57A, so the electrode is located inside the ignition hole 57′, and fastens against the housing bottom wall 58′. An ignition hole 63A projects through the housing bottom wall 58′ up through the center of the inner housing wall 64′ located between the compressor rotor holes 43′ and 46′ and the turbine rotor holes 45A and 48A. A bolt hole 65′ located to one side of the ignition hole 63A and a bolt hole 66′ located to the other side of the ignition hole 63A project up through the inner housing wall 64′ passing from the bottom to the top of the housing assembly 20A. A spark ignition device 67′ threads into the ignition hole 63A, so the electrode is located inside the ignition hole 63A, and fastens against the housing bottom wall 58′. Bolts thread into the bolt holes 60′, 61′, 65′, and 66′ in the housing assembly bottom half and fasten the halves of the housing assembly 20A together.

A combustion passage 68A is formed in the housing assembly 20A from the outer walls of the turbine rotor holes 44A and 47A and passes horizontally through the housing assembly 20A connecting to the ignition hole 57A. A combustion passage 69A is formed in the housing assembly 20A from the outer walls of the turbine rotor holes 45A and 48A and passes horizontally through the housing assembly 20A connecting to the ignition hole 63A. A compressor discharge passage 70′ connects the ignition hole 57A to the ignition hole 63A.

A vertical coolant passage 75′ is formed in the inner housing wall 59′ and is located between the compressor rotor hole 43′ and the turbine rotor hole 44A and extends downward partially surrounding the drive shaft 22A. A vertical coolant passage 76′ is formed in the inner housing wall 59′ and is located between the compressor rotor hole 46′ and the turbine rotor hole 47A and extends downward partially surrounding the drive shaft 27A. A vertical coolant passage 77 is formed in the inner housing wall 64′ and is located between the compressor rotor hole 43′ and the turbine rotor hole 45A and extends downward partially surrounding the drive shaft 24A. A vertical coolant passage 78′ is formed in the inner housing wall 64′ and is located between the compressor rotor hole 46′ and the turbine rotor hole 48A and extends downward partially surrounding the drive shaft 29A.

A semi-circle horizontal coolant passage 79A connects the vertical coolant passage 75′ and the vertical coolant passage 77′ together and extends from the detachable housing front wall 32A to the detachable housing back wall 35A. A semi-circle horizontal coolant passage 80A connects the vertical coolant passage 76′ and the vertical coolant passage 78′ together and extends from the detachable housing front wall 32A to the detachable housing back wall 35A.

A coolant inlet hole 81′ passes through the housing top wall 72′ and connects to the semi-circle horizontal coolant passage 80A. A coolant inlet flange 82′ projects upward from the surface of the housing top wall 72′ and is axially aligned with the coolant inlet hole 81′. A coolant outlet hole 83′ passes through the housing bottom wall 58′ and connects to the semi-circle horizontal coolant passage 79A. A coolant outlet flange 84′ projects downward from the surface of the housing bottom wall 58′ and is axially aligned with the coolant outlet hole 83′.

To start the engine an on/off switch is thrown to energize a starter 87′ that rotates the drive shaft 24A. Rotation of the drive shaft 24A rotates the compressor rotor 21′. Rotation of compressor rotor 21′ rotates the compressor rotor 26′ and the compressor draws air into the engine through the intake port 53′. The fuel injector 55 injects fuel into the intake port 53′ and the fuel/air mixture is discharged into the compressor discharge passage 70′ and flows into the ignition holes 57A and 63A. The spark ignition devices 62′ and 67′ ignite the fuel mixture and the hot gases pass into the combustion passages 68A and 69A. Gases in the combustion passage 68A flow into the turbine rotor holes 44A and 47A and the gas pressure between the counter rotating turbine rotors 23A and 28A drives them in opposite directions accelerating them. Gas driving the turbine rotors 23A and 28A passes out of the top exhaust port 49A. Gases in the combustion passage 69A flow into turbine rotor holes 45A and 48A and the gas pressure between the counter rotating turbine rotors 25A and 30A drives them in opposite directions accelerating them. Gas driving the turbine rotors 25A and 30A passes out of the top exhaust port 50A. The turbine rotors 23A and 25A drive the drive shafts 22A and 24A which drive the compressor rotor 21′. The turbine rotors 28A and 30A drive the drive shafts 27A and 29A which drive the compressor rotor 26′. Acceleration of the compressor rotors 21′ and 26′ draws in more air and the fuel injector 55 injects more fuel into the engine increasing the amount of fuel and air burned per unit time increasing the engines power. A coolant pump 85′ pumps coolant through the engine coolant passages, a fuel pump 86′ supplies fuel, and an alternator 88′ supplies running current. An engine management system controls engine operation and performance.

FIG. 10 and FIG. 11 show a version of the second embodiment using a lobular gear compressor. Compressor rotors 21A and 26A replace compressor rotors 21′ and 26,′ turbines 23B, 25B, 28B, and 30B replace turbines 23A, 25A, 28A, and 30A, turbine holes 44B, 45B, 47B, and 48B replace turbine holes 44A, 45A, 47A, and 48A, drive shafts 22B, 24B, 27B, and 29B replace drive shafts 22A, 24A, 27A, and 29A, drive shaft holes 31B and 38B replace drive shaft holes 31A and 38A, bolt holes 60A, 61A, 65A, and 66A replace bolt holes 60′, 61′, 65′, and 66′, and semi-circle horizontal coolant passages 79B and 80B replace semi-circle horizontal coolant passages 79A and 80A. The engine functions the same way and the other parts of the machine are the same.

While the preferred embodiments of the invention have been shown and described, it is to be understood that the disclosure is for the purpose of illustration and that various changes and modifications may be made without departing from the scope of the invention as set forth in the appended claims.

### PARTS

10—GAS TURBINE ENGINE
20—HOUSING ASSEMBLY
21—COMPRESSOR ROTOR1
22—DRIVE SHAFT1
23—TURBINE ROTOR1
24—DRIVE SHAFT2
25—TURBINE ROTOR2
26—COMPRESSOR ROTOR2
27—DRIVE SHAFT3
28—TURBINE ROTOR3
29—DRIVE SHAFT4
30—TURBINE ROTOR4
31—COMPRESSOR DRIVE SHAFT HOLE1
32—OUTER HOUSING WALL1
33—BEARING1
34—BEARING ENCLOSURE1
35—OPPOSITE OUTER HOUSING WALL2
36—BEARING2
37—BEARING ENCLOSURE2
38—COMPRESSOR DRIVE SHAFT HOLE2
39—BEARING3
40—BEARING ENCLOSURE3
41—BEARING4
42—BEARING ENCLOSURE4
43—COMPRESSOR ROTOR HOLE1
44—TURBINE ROTOR HOLE1
45—TURBINE ROTOR HOLE2
46—COMPRESSOR ROTOR HOLE2
47—TURBINE ROTOR HOLE3
48—TURBINE ROTOR HOLE4
49—EXHAUST PORT1
50—EXHAUST PORT2
51—EXHAUST PORT3
52—EXHAUST PORT4
53—INTAKE PORT
54—CARBURETOR
56—THROTTLE BUTTERFLY VALVE
57—IGNITION HOLE1
58—HOUSING BOTTOM WALL
59—INNER HOUSING WALL1
60—BOLT HOLE1
61—BOLT HOLE2
62—SPARK IGNITION DEVICE1
63—IGNITION HOLE2
64—INNER HOUSING WALL2
65—BOLT HOLE3
66—BOLT HOLE4
67—SPARK IGNITION DEVICE2
68—COMBUSTION PASSAGE1
69—COMBUSTION PASSAGE2
70—COMPRESSOR DISCHARGE PASSAGE
71—TOP HORIZONTAL COOLANT PASSAGE
72—HOUSING TOP WALL
75—VERTICAL COOLANT PASSAGE1
76—VERTICAL COOLANT PASSAGE2
77—VERTICAL COOLANT PASSAGE3
78—VERTICAL COOLANT PASSAGE4
79—SIDE HORIZONTAL COOLANT PASSAGE1
80—SIDE HORIZONTAL COOLANT PASSAGE2
81—COOLANT INLET HOLE
82—COOLANT INLET FLANGE
83—COOLANT OUTLET HOLE
84—COOLANT OUTLET FLANGE
85—COOLANT PUMP
86—FUEL PUMP
87—STARTER
88—ALTERNATOR
10′—GAS TURBINE ENGINE
20A—HOUSING ASSEMBLY
21′—COMPRESSOR ROTOR1
21A—COMPRESSOR ROTOR1
22A—DRIVE SHAFT1
22B—DRIVE SHAFT1
23A—TURBINE ROTOR1
23B—TURBINE ROTOR1
24A—DRIVE SHAFT2
24B—DRIVE SHAFT2
25A—TURBINE ROTOR2
25B—TURBINE ROTOR2
26′—COMPRESSOR ROTOR2
26A—COMPRESSOR ROTOR2
27A—DRIVE SHAFT3
27B—DRIVE SHAFT3
28A—TURBINE ROTOR3
28B—TURBINE ROTOR3
29A—DRIVE SHAFT4
29B—DRIVE SHAFT4
30A—TURBINE ROTOR4
30B—TURBINE ROTOR4
31A—COMPRESSOR DRIVE SHAFT HOLE1
31B—COMPRESSOR DRIVE SHAFT HOLE2
32A—DETACHABLE OUTER HOUSING WALL1
33′—BEARING1
34′—BEARING ENCLOSURE1
35A—OPPOSITE DETACHABLE OUTER HOUSING WALL2
36′—BEARING2
37′—BEARING ENCLOSURE2
38A—COMPRESSOR DRIVE SHAFT HOLE2
38B—COMPRESSOR DRIVE SHAFT HOLE
39′—BEARING3
40′—BEARING ENCLOSURE3
41′—BEARING4
42′—BEARING ENCLOSURE4
43′—COMPRESSOR ROTOR HOLE1
44A—TURBINE ROTOR HOLE1
44B—TURBINE ROTOR HOLE1
45A—TURBINE ROTOR HOLE2
45B—TURBINE ROTOR HOLE2
46′—COMPRESSOR ROTOR HOLE2
47A—TURBINE ROTOR HOLE3
47B—TURBINE ROTOR HOLE3
48A—TURBINE ROTOR HOLE4
48B—TURBINE ROTOR HOLE4
49A—EXHAUST PORT1
50A—EXHAUST PORT2
53′—INTAKE PORT
54A—INJECTOR HOLDER
55—FUEL INJECTOR
56A—TURBINE SIDE WALL
57A—IGNITION HOLE1
58′—HOUSING BOTTOM WALL
59′—INNER HOUSING WALL1
60′—BOLT HOLE1
60A—BOLT HOLE1
61′—BOLT HOLE2
62a—BOLT HOLE2
62′—SPARK IGNITION DEVICE1
63A—IGNITION HOLE2
64′—INNER HOUSING WALL2
65′—BOLT HOLE3
65A—BOLT HOLE3
66′—BOLT HOLE4
66A —BOLT HOLE4
67′—SPARK IGNITION DEVICE2
68A—COMBUSTION PASSAGE1
69A—COMBUSTION PASSAGE2
70′—COMPRESSOR DISCHARGE PASSAGE
72′—HOUSING TOP WALL
75′—VERTICAL COOLANT PASSAGE1
76′—VERTICAL COOLANT PASSAGE2
77′—VERTICAL COOLANT PASSAGE3
78′—VERTICAL COOLANT PASSAGE4
79A—SEMI-CIRCLE HORIZONTAL COOLANT PASSAGE1
79B—SEMI-CIRCLE HORIZONTAL COOLANT PASSAGE1
80A—SEMI-CIRCLE HORIZONTAL COOLANT PASSAGE2
80B—SEMI-CIRCLE HORIZONTAL COOLANT PASSAGE2
81′—COOLANT INLET HOLE
82′—COOLANT INLET FLANGE
83′—COOLANT OUTLET HOLE
84′—COOLANT OUTLET FLANGE
85′—COOLANT PUMP
86′—FUEL PUMP
87′—STARTER
88′—ALTERNATOR

I claim:

1. A gas turbine engine comprised of a housing means to contain spaces within the engine, a fuel supply means to supply fuel to the engine, a spark ignition means to ignite the fuel mixture, a compressor rotor including a drive shaft projecting from said compressor rotor, the improvement comprising a turbine rotor formed on said drive shaft.

2. The improvement as defined in claim 1 wherein said compressor rotor is comprised of the positive displacement type.

3. The improvement as defined in claim 2 wherein said housing means includes spaces to contain two said compressor rotors.

4. The improvement as defined in claim 3 wherein said housing means includes passage means to pass said fuel supply from said compressors discharge side to said turbines up steam side.

5. The improvement as defined in claim 2 wherein said compressor rotor is comprised of a gear.

6. The improvement as defined in claim 5 wherein said compressor rotor is comprised of a lobular gear.

7. The improvement as defined in claim 1 wherein said fuel supply means includes a carburetor.

8. The improvement as defined in claim 1 wherein said fuel supply means includes a fuel injector.

9. The improvement as defined in claim 1 wherein said turbine rotor is comprised of a paddle wheel.

10. The improvement as defined in claim 1 wherein said paddle wheel has side walls.

11. The improvement as defined in claim 7 wherein said compressor rotor is comprised of a positive displacement type type.

12. The improvement as defined in claim 11 wherein said spark ignition means includes a spark plug.

13. The improvement as defined in claim 1 wherein said drive shaft projects from each side of said compressor rotor with said turbine rotor formed on each said drive shaft.

14. The improvement as defined in claim 8 wherein said housing means includes passage means to pass said fuel supply from said compressors discharge side to said turbines down steam side.

15. The improvement as defined in claim 10 wherein said housing means includes cooling means.

16. The improvement as defined in claim 11 wherein said housing means includes drive shaft holes to enclose said compressor rotor dive shafts.

17. The improvement as defined in claim 16 wherein said housing is divided along the axis of said compressor rotor drive shaft holes.

18. A gas turbine engine comprised of a housing means to contain spaces within the engine, a fuel supply means to supply fuel to the engine, a spark ignition means to ignite the fuel mixture, a compressor rotor including a drive shaft projecting from said compressor rotor, cooling means to cool the engine, bearing means to support rotating parts, a turbine rotor formed on said drive shaft, the improvement wherein said compressor rotor is of the positive displacement type.

19. The apparatus of a gas turbine engine which comprises:
1. a housing containing two compressor rotor spaces divided by an interior wall from two turbine rotor spaces;
2. cooling passages formed in said interior wall and said housing and connected together;
3. said compressor rotor spaces formed so compressor rotors may be geared together;
4. said compressor rotor spaces connected to said turbine rotor spaces by two drive shaft spaces and a fuel passage space;
5. said fuel passage space includes an ignition space to hold a spark ignition device so it can project into said fuel passage space;
6. said housing includes an intake space connected to said compressor rotor space and an exhaust space connected to said turbine rotor space;
7. said drive shaft space connected to the opposite side of said turbine space and one side of said housing means;
8. a drive shaft comprised of a round shaft and a compressor rotor and a turbine rotor projecting from said round shaft;
9. two said drive shafts installed within said housing;
10. a fuel supply means to supply fuel to said intake port and spark ignition means to ignite fuel within said fuel passage means;
11. starter means connected to said drive shaft to start the engine.

20. The method of:
1. compressing fuel within a housing means with a compressor means joined by a drive shaft to a turbine means;
2. pumping said compressed fuel with said compressor means through said housing means to said turbine means;
3. igniting said fuel on the up stream side of said turbine;
4. exhaust said ignited fuel through said turbine out through said housing means to produce torque to drive said compressor means
